(19) United States
(12) Patent Application Publication
(10) Pub. No.: US 2009/0045644 A1
(43) Pub. Date: Feb. 19, 2009

(54) MOBILE COLLECTION SYSTEM HAVING A BIN TUNNEL WITH COLLAPSIBLE SIDES

(75) Inventors: ROBERT K. GLASS, Cambridge (CA); David K. Yamamoto, Paris (CA); Ian R. Pollock, Kitchener (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(73) Assignee: Shred-Tech Corporation

(21) Appl. No.: 12/193,032

(22) Filed: Aug. 17, 2008

Related U.S. Application Data
(60) Provisional application No. 60/956,356, filed on Aug. 16, 2007.

(51) Int. Cl. B60P 3/40

(52) U.S. Cl. 296/24.3

(57) ABSTRACT

A truck box of a tuck has a bin tunnel with collapsible sides to load content into the truck box from a bin that is sized to fit within the bin tunnel when the bin tunnel is in an open position. When the bin tunnel is in a closed position, a footprint of the bin tunnel is very small compared to a footprint of the bin tunnel in the open position because the sides are retracted.

Applicant claims the benefit of U.S. Provisional Application Ser. No. 60/956,356 filed on Aug. 16, 2007.

### BACKGROUND OF THE INVENTION

1. Field of the Invention

This invention relates to a mobile collection system with a bin tunnel mounted on a truck box of a truck to load content into the truck box using a bin that is sized to fit into the bin tunnel when the bin tunnel is in an open position, the bin tunnel having collapsible sides, resulting in a very small footprint when the bin tunnel is in a closed position.

2. Description of the Prior Art

It is known to have mobile collection systems with a bin tunnel to load the content of a bin into a truck box of a truck. Bin tunnels have a closed position in which an outer wall of the bin tunnel is flush with an outer wall of the truck box. When the truck is being driven, the bin tunnel is in the closed position. When the truck is stopped and it is desired to empty the contents of one or more bins into the truck box, the bin tunnel is pulled outward from the truck box to an open position. The bin tunnel and the bin to be emptied are appropriately sized relative to one another so that the bin will fit into the bin tunnel when the bin tunnel is in the open position. A bin lifting mechanism is mounted on the inner wall of the bin tunnel to lift up the bin and turn the bin upside down to empty the contents into the truck box. The inner wall of the bin tunnel is a recessed wall built into the truck box. Where the bin contains items to be shredded, the truck box can contain a shredder or the truck can simply be a collection vehicle that delivers the contents to another location to be shredded. A bin tunnel is described in Yamamoto et al U.S. Pat. No. 6,588,691 issued Jul. 8, 2003.

The extendable and retractable portion of existing bin tunnels have the same dimensions whether the bin tunnel is in the open position or in the closed position. The truck box must be designed to accommodate the size of the extendable and retractable portion of the bin tunnel in the closed position and the available space within the bin tunnel for storage of content, whether shredded or unshredded, or other storage is reduced by the depth of the extendable and retractable portion of the bin tunnel as the extendable and retractable portion of the bin tunnel must fit inside the truck box when the bin tunnel is in the closed position. Since internal size of the truck box available for content storage is reduced, this reduces the size of the payload of the truck and decreases the efficiency of the truck. Also, for mobile document systems where content is collected by a truck for shredding at another location, since the bin tunnel narrows the inner storage width of the truck box by the same distance that the bin tunnel extends outside of the sidewall of the truck box when the bin tunnel is in the open position, a standard size fork lift will not fit into the truck box for unloading the content. An upper portion of the bin tunnel, being an upper portion of the lift mechanism extends further into the truck box beyond the inner wall making the inner width of the truck box even smaller.

Also, when customers wish to have documents shredded, there is a security issue in that the documents within the collection truck must be inaccessible to third parties before the documents are shredded. With existing bin tunnels, when the bin tunnel is in a closed position, there is still sufficient space within the bin tunnel for a person to access the interior of the truck body through the bin tunnel.

### SUMMARY OF THE INVENTION

It is an object of the present invention to provide a mobile collection system having a bin tunnel with collapsible sides so that a depth of the bin tunnel in a closed position is substantially less than fifty (50) percent of the depth of the bin tunnel in an open position. It is a further object of the present invention to provide a mobile collection system having more than one bin tunnel with collapsible sides mounted on a side of a truck box of a truck.

A mobile collection system comprises a truck with a truck box and a bin tunnel located in a side of the truck box to load content from a bin into the truck box. The bin is sized to fit within the bin tunnel when the bin tunnel is in an open position. The bin tunnel has a fixed inner wall and an outer wall with two sidewalls with slidable supports to move the outer wall and sidewalls between a closed position, the open position relative to the inner wall. The sidewalls are collapsible so that a distance between the inner wall and the outer wall when the bin tunnel is in the closed position is substantially less than a distance between the inner wall and the outer wall when the bin tunnel is in the open position.

A mobile collection system comprises a truck having a truck box with a bin tunnel located in a side of the truck box to load content from a bin into the truck box. The bin is sized to fit within the bin tunnel on a lift mechanism that can raise and tip the bin. The bin tunnel has a fixed inner wall in the truck box, two sidewalls and an outer wall with slidable supports to enable the sidewalls and the outer wall to be moved outward and inward relative to the inner wall between an open position and a closed position respectively. The sidewalls are collapsible so that a depth of the bin tunnel in the closed position is significantly less than a depth of the bin tunnel in the open position. The bin tunnel fits within the bin tunnel when the bin tunnel is in the open position, the lift mechanism being mounted on the inner wall. The inner wall is a recessed wall of the truck box, the outer wall being substantially flush with a side of the truck box when the bin tunnel is in the closed position.

A mobile collection system having a truck box and a bin tunnel located in a side of the truck box to load content into the truck box using a bin that is sized to fit into the bin tunnel. The bin tunnel has an outer portion being a front, a top and two sides and an inner portion with a lift mechanism mounted on an inner wall thereof, the inner wall being fixed. The outer portion is slidably supported on the truck box to enable the outer portion to be moved outward from the truck box to an open position of the bin tunnel and moved inward to a closed position of the bin tunnel in which the front is substantially flush with an outer wall of the truck box. The outer portion of the bin tunnel is supported on the truck box independently of the sides, the sides being collapsible relative to the front. In the open position the bin tunnel having sufficient height, depth and width to receive the bin, the lift mechanism in the bin tunnel being constructed to removably connect to the bin and to raise the bin upward within the bin tunnel and tilt the bin and empty the contents of the bin into the truck box. A depth of the bin tunnel in the closed position is substantially less than fifty (50) percent of a depth of the bin tunnel in the open position, the sides of the bin tunnel being extended in the open position and retracted in the closed position.

### BRIEF DESCRIPTION OF THE DRAWINGS

FIG. 1 is a schematic top view of a truck with a truck box having two bin tunnels that are in an open position;

FIG. 2 is a side view of the truck of FIG. 1;

FIG. 3 is a front view of the truck of FIG. 1;

FIG. 4A is a perspective view of a truck box with two bin tunnels in an open position;

FIG. 4B is a schematic top view of the truck box with the bin tunnels in the open position;

FIG. 5 is a top view of a bin tunnel in a partially shown truck box where the bin tunnel is in a closed position;

FIG. 6A is a side view of the truck box with the bin tunnels in a closed position;

FIG. 6B is a schematic top view of a truck box with one of the bin tunnels shown in a closed position;

FIG. 7 is a perspective view of a truck box having two bin tunnels in a closed position;

FIG. 8 is a top view of the truck box of FIG. 7;

FIG. 9 is a schematic front view of a truck box with a bin tunnel in an open position;

FIG. 10 is a schematic top view of a truck box having two bin tunnels in closed positions;

FIG. 11 is an enlarged front view of a locking cylinder circled in FIG. 10:

FIG. 12 is an enlarged top partially sectional view of one side wall in a closed position;

FIG. 13 is a perspective view of a partial bin tunnel when viewed from an inside;

FIG. 14A is a perspective view of the partial bin tunnel of FIG. 13 when viewed from an outside;

FIG. 14B is a partial side view of an end of a slidable support beam with a caster thereon;

FIG. 15 is a side view showing a slidable support beam at a bottom of the bin tunnel;

FIG. 16 is a schematic perspective partial view of an interior of the truck box; and

FIG. 17 is an enlarged view of that part of the interior of the truck box enclosed within a circle in FIG. 16.

### DETAILED DESCRIPTION OF A PREFERRED EMBODIMENT

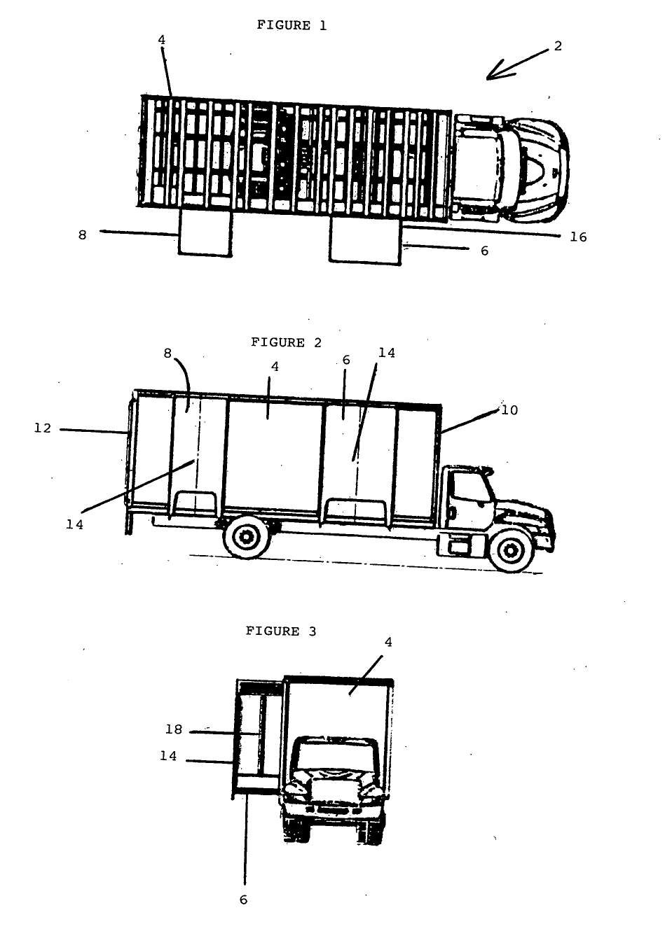

In FIGS. 1 to 3, a truck 2 has a truck box 4 with two schematically shown bin tunnels 6, 8 in an open position. The bin tunnels 6, 8 are located on a passenger side of the truck 2 and the bin tunnel 6 is located near a front 10 of the truck box 4 and the bin tunnel 8 is located near a rear 12 of the truck box 4. The bin tunnel 6 is larger than the bin tunnel 8 and each bin tunnel has an outer wall 14 and two sidewalls 16. The bin tunnel 6 can receive larger bins (not shown) than the bin tunnel 8. In FIG. 3, it can be seen that the sidewalls 16 (only one of which is shown) is collapsible as the sidewall has a fold line 18 therein. The roof and floor have been omitted from FIG. 1 to show the structural supports.

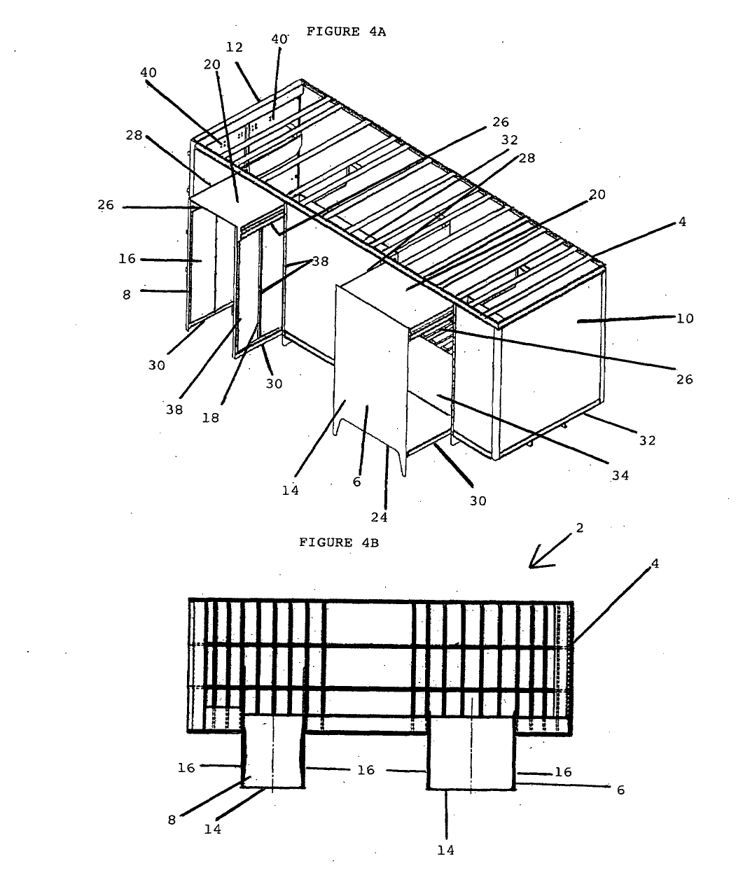

In FIG. 4, both bin tunnels 6, 8 are in the open position and each bin tunnel has a roof 20 thereon. The bin tunnel 6 has an outer wall or front 14 installed thereon but no sidewalls are installed. The outer wall 14 has an inverted U-shaped lower portion 24 to provide clearance for a bin (not shown) that is sized for use with the bin tunnel 6. A drawer slide 26 is located at a top 28 of the bin tunnels 6, 8. There are two drawer slides 26 on each bin tunnel 6, 8, one on each side of each bin tunnel. Each bin tunnel 6, 8 has two slidable beams 30 at a lower end of each side to provide support for each bin tunnel. The slidable beams 30 slide in and out with the bin tunnel beneath a floor 32 of the truck box 4. Each bin tunnel 6, 8 has an inner wall 34 that is part of the truck box 4 and does not move when the bin tunnel moves between an open and closed position. Each bin tunnel 6, 8 has collapsible sidewalls 16 thereon but the sidewalls have been omitted from the bin tunnel 6 to expose an interior. The sidewalls 16 shown on the bin tunnel 8 are hinged on their outer and inner longitudinal edges 38 so that the sidewalls are bifolds and fold along the foldline 18 when the bin is in the closed position (not shown in FIG. 4). The truck box 4 has rear doors 40 that allow access to an interior of the truck box. The roof of the truck box 4 has been deleted to expose an interior. Each of the bin tunnels has a lift mechanism that is conventional and, except for FIGS. 16 and 17, has been omitted from the drawings. The roof of the truck box has been deleted to expose an interior. The same reference numerals are used in FIG. 4 as those used in FIGS. 1 to 3 for those components that are identical. The two bin tunnels 6, 8 are of different sizes but the components of the two bin tunnels are numbered identically.

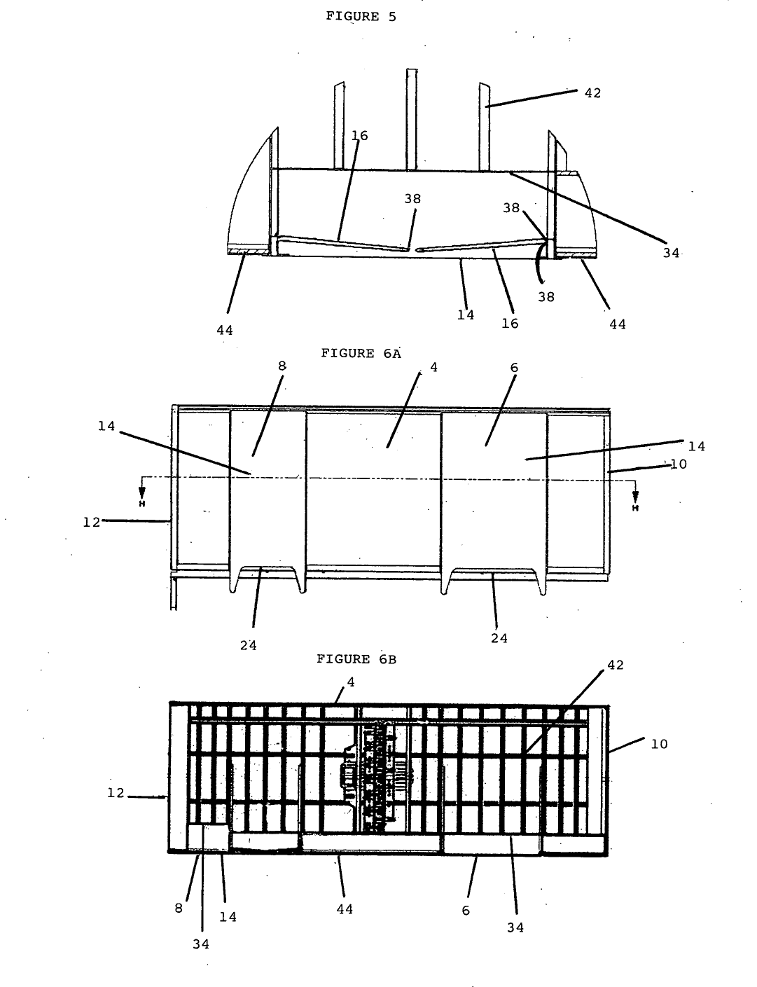

In FIGS. 5, 6A and 6B, FIG. 6A is a side view of the truck box 4 and FIG. 6B is a sectional view of the truck box along the section H-H of FIG. 6A. The floor has been deleted in FIG. 6B to show the structural supports 42 beneath the floor. The same reference numerals are used in FIGS. 5, 6A and 6B as those used in FIGS. 1 to 4 for those components that are identical. In FIG. 6B, the inner wall 34 of each bin tunnel 6, 8 extends along the truck box 4 from the front 10 almost to the rear 12. The bin tunnel 6 has been deleted from FIG. 6B except for the inner wall 34 which is a fixed part of the truck box 4. FIG. 5 is an enlarged view of that part of FIG. 6B contained within the circle around the bin tunnel 8. The bin tunnel 8 is in the closed position and the outer wall 14 is substantially flush with the side wall 44 of the truck box 4. The sidewalls 16 are folded as shown and extend inward in the bin tunnel to almost meet one another at a center thereof. By comparing FIGS. 4 and 6B, a distance from the outer wall 14 to the inner wall 34 when the bin tunnels 6, 8 are in the closed position compared to the distance when the bin tunnels are in the open position is significantly less and is substantially less than fifty (50) percent, but still more preferably less than forty (40) percent. More preferably, the distance is less than thirty (30) percent and is substantially twenty-seven (27) percent. A footprint of the bin tunnel is the closed position is substantially less than fifty (50) percent of a footprint of the bin tunnel in the open position.

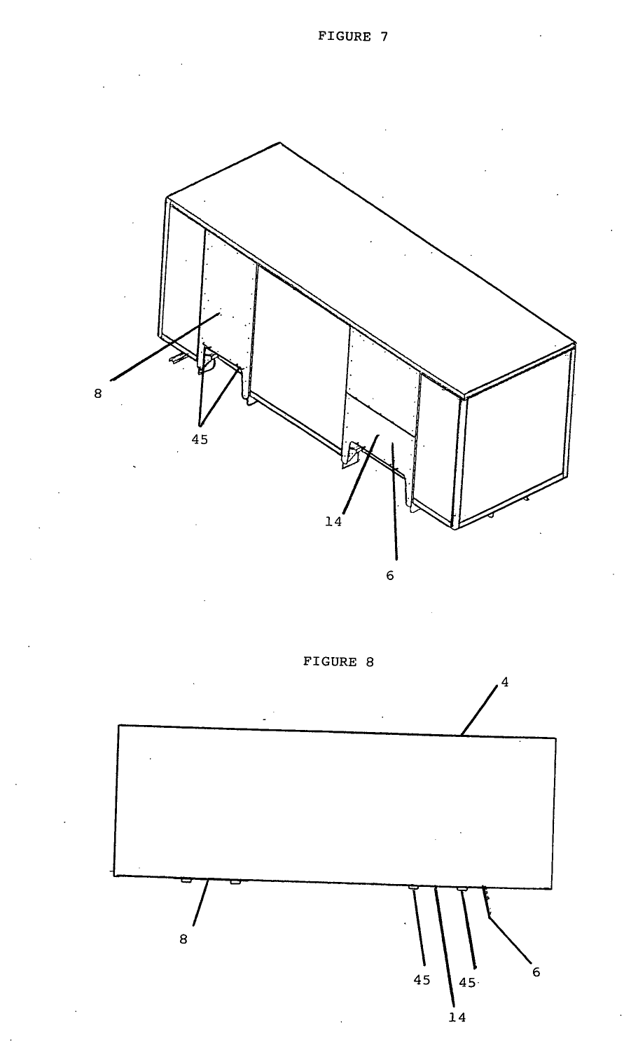

In FIGS. 7 and 8, the same reference numerals are used as those used in FIGS. 1 to 6B for those components that are identical. Each of the bin tunnels 6, 8 has two handles 45 extending outward from the outer wall 14 to enable an operator to pull the bin tunnels outward from the closed position to the open position and to push the bin tunnels inward from the open position to the closed position when desired.

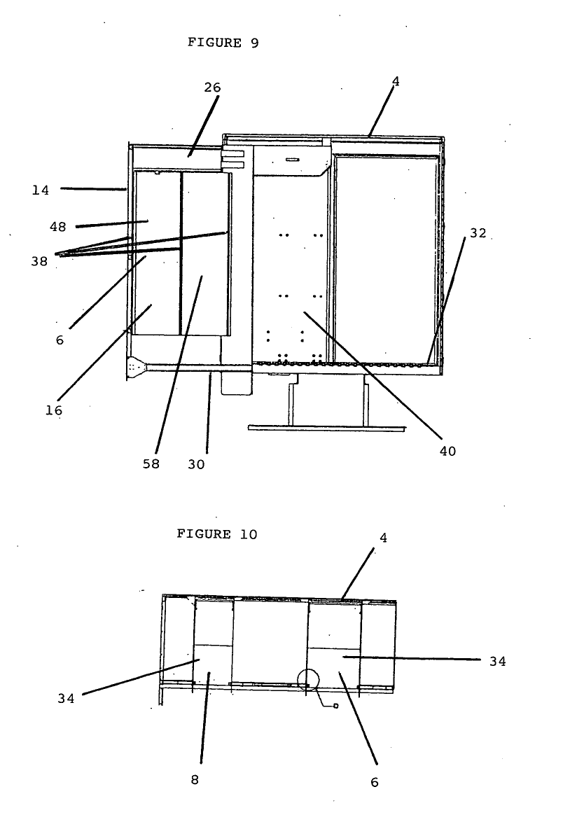

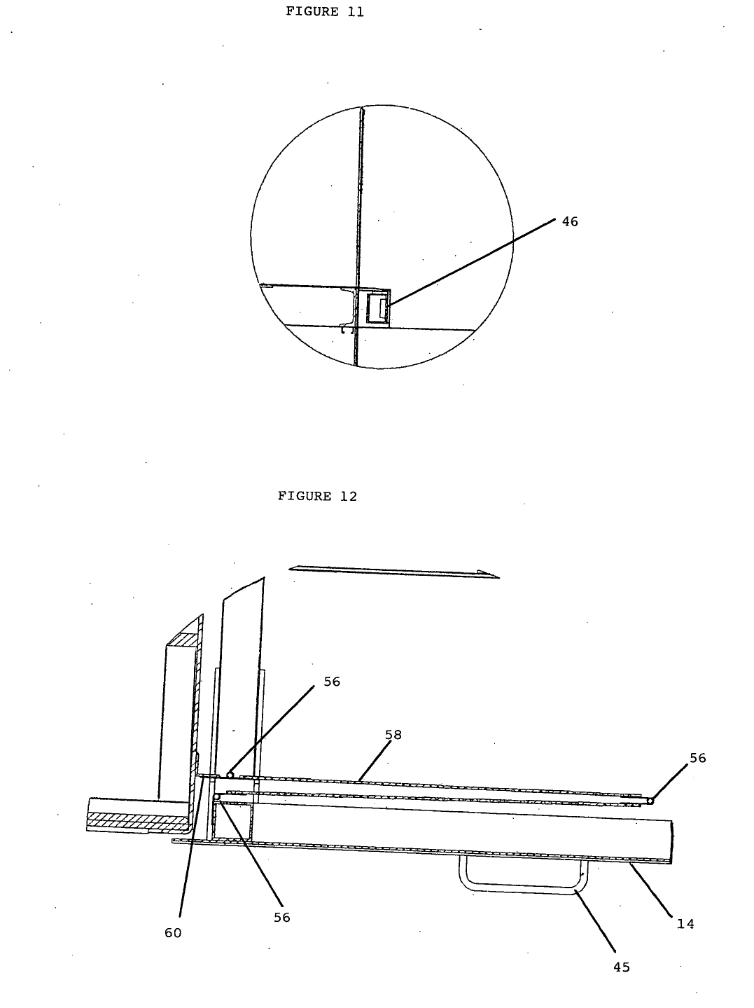

In FIGS. 9 to 12, the same reference numerals are used as those in FIGS. 1 to 9 for those components that are identical. FIG. 11 is an enlarged view of detail D from FIG. 10 showing a locking cylinder 46 at a lower left corner of the bin tunnel 6. There are other locking cylinders at a lower left corner of bin tunnel 8 and locking cylinders at the lower right corner of each of the bin tunnels 6, 8. The bin tunnels 6, 8 are omitted from FIG. 10 except for the inner wall 34 to expose the locking cylinder 46. Preferably, there are also upper locks on each of the bin tunnels 6, 8. The locking cylinders and the upper locks lock each of the bin tunnels in the closed position when the truck is travelling and also to prevent access to an interior of the truck box for security purposes. In FIG. 9, the drawer slide 26 is partially shown as is the beam 30. FIG. 12 provides a further enlarged view of one of the sidewalls 16 in the closed position. There is a hinge 56 along each of the longitudinal edges 38. The hinge 56 on an inner panel 58 is adjustable by means of a bolt 60. The outer wall 14 has a handle 62 thereon. There are two handles 45 on each outer wall 14 preferably located symmetrically about a longitudinal center line of said outer wall 14. Only half of the outer wall 14 is shown in FIG. 12. The handles 45 allow an operator to manually pull the bin tunnel outward to the open position and inward to the closed position.

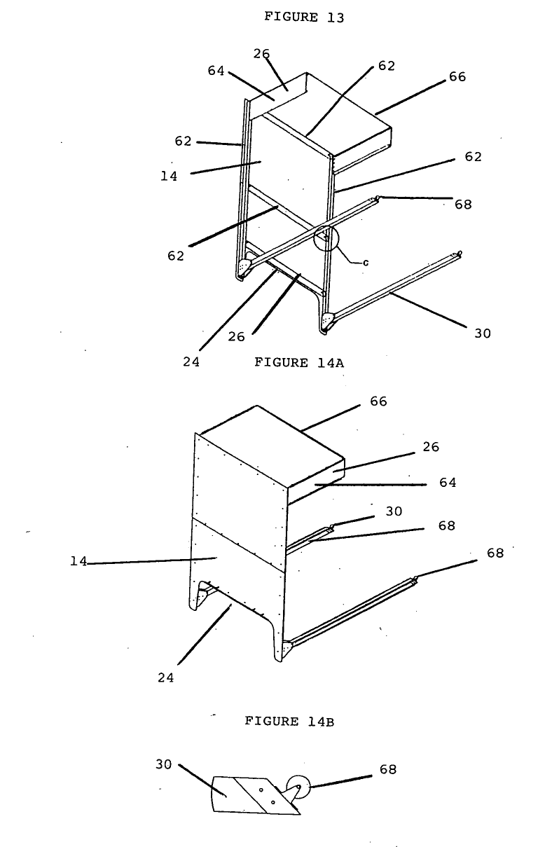

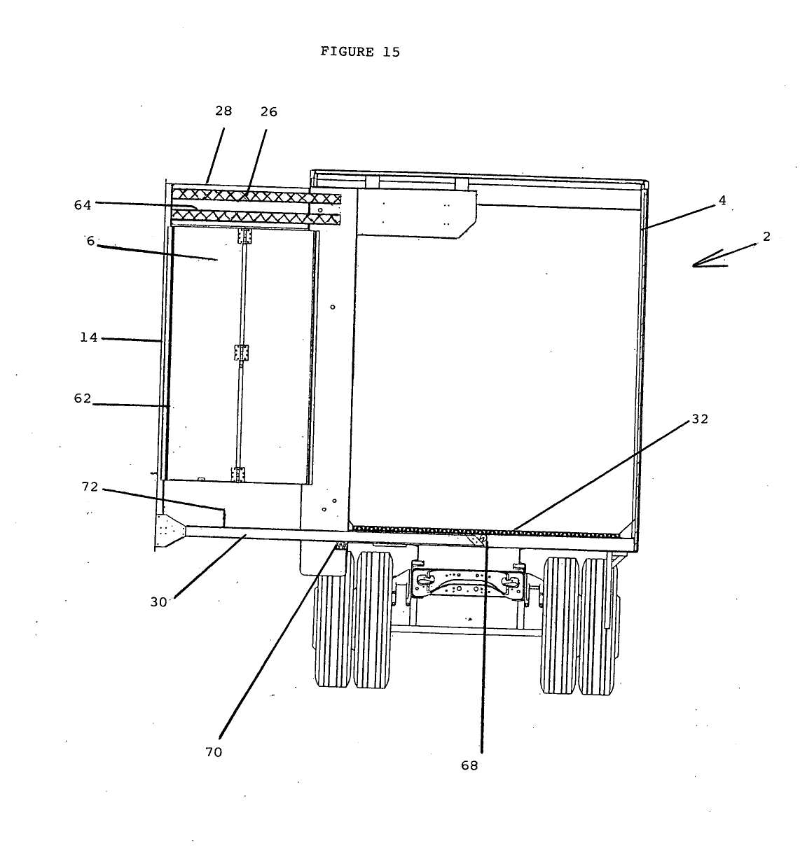

FIGS. 13 and 14A are perspective views of part of the bin tunnel 8. The same reference numerals are used in FIGS. 13 and 14A as those used in FIGS. 1 to 12 for those components that are identical. The outer wall 14 has frame members 62 on an interior thereof an outer section 64 of the drawer slide 26 are connected at an inner end by a support member 66. The slidable beams 30 have a caster 68 at an inner end thereof. As shown in FIG. 14B, the casters 68 (only one of which is shown) extend slightly above an upper surface of each of the beams 30 to make it easier for a user to open and close the bin tunnel.

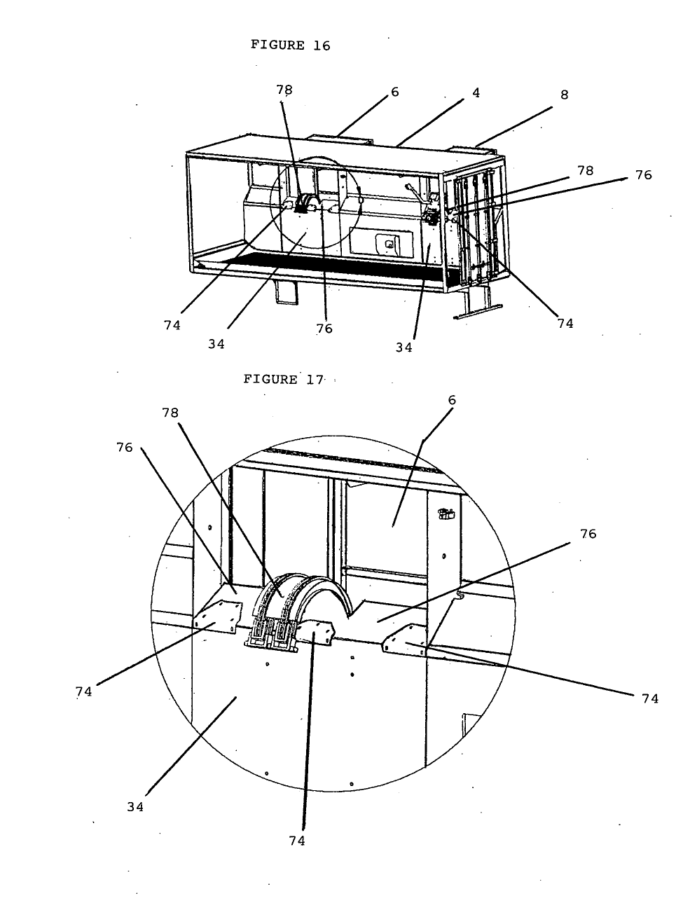

In FIG. 15, the same reference numerals are used as those used in FIGS. 1 to 14 for those components that are identical. There is a second caster 70 mounted beneath the truck box 4 to support an outer portion of the beams 30 (only one of which is shown in FIG. 15) along with the caster 68 which is mounted on an inner end of the beam. The caster 68 is mounted to be slightly above an upper surface 72 of the beam 30 to reduce the friction between the beams and the truck body to enable the beams to be able be moved inward and outward more easily. The sidewalls have been omitted from the bin tunnel 6 in FIG. 15.

In FIGS. 16 and 17, metal plates 74 extend from the inner wall 34 outward to support a seal 76 that extends across the bin tunnel 6 to substantially close off a vertical passage of said bin tunnel 6 (best seen in FIG. 17). The seal is shaped to accommodate a lift mechanism 78 mounted on the inner wall 34. The same reference numerals are used in FIGS. 16 and 17 as those used in FIGS. 1 to 15 for those components that are identical.

The bin tunnel 8 has a similar seal sized to fit the bin tunnel 8, but that seal is not shown in the drawings.

Since the inner wall 34 of the bin tunnel is recessed in the side of the truck box by a much shorter distance than the inner wall of previous bin tunnels, a much greater volume of the truck box is available for storage of content or for shredding content or for other storage. While the truck and truck box shown are mobile collection systems that do not include a shredder, but are designed to pick up content and deliver the content to a central location for shredding, a bin tunnel with collapsible sides can be used with trucks and truck boxes containing shredders. The inner wall is recessed into the side of the truck box by substantially thirteen (13) inches thereby using up only a very small portion of the volume of the truck box. The inner wall can extend along an entire length of the truck box and more than one bin tunnel can be mounted on the truck box. The bin tunnels can be of the same size or they can be of different sizes to accommodate bins of different sizes. While two bin tunnels are shown in the drawings, more than two bin tunnels can be used on one truck box. Also, the bin tunnels can be identical to one another.

We claim:

1. A mobile collection system comprising a truck with a truck box and a bin tunnel located in a side of said truck box to load content from a bin into said truck box, said bin being sized to fit within said bin tunnel when said bin tunnel is in an open position, said bin tunnel having a fixed inner wall and an outer wall with two side walls with slidable supports to move said outer wall and side walls between a closed position and said open position relative to said inner wall, said side walls being collapsible so that a distance between said inner wall and said outer wall when said bin tunnel is in said closed position is substantially less than a distance between said inner wall and said outer wall when said bin tunnel is in said open position.

2. A collection system as claimed in claim 1 wherein said outer wall is flush with said side of said truck box when said bin tunnel is in said closed position and said inner wall is recessed into said side of said truck box.

3. A collection system as claimed in claim 2 wherein said inner wall has a lift mechanism mounted thereon and is located in said truck box inside of a plane through said side of said truck box.

4. A collection system as claimed in claim 3 wherein said bin tunnel in said closed position is just large enough to accommodate said lift mechanism and said collapsible walls.

5. A collection system as claimed in claim 2 wherein access to said truck box through said bin tunnel is closed off when said bin tunnel is in said closed position.

6. A collection system as claimed in claim 1 wherein said sidewalls are bifold panels that fold substantially in half when said bin tunnel is in a closed position and extend fully outward when said bin tunnel is in said open position.

7. A collection system as claimed in claim 6 wherein said bifold panels are hinged along side edges and an inner edge of each inner panel is located inside a vertical plane through said side of said truck box.

8. A collection system as claimed in claim 1 wherein a lower end of said bin tunnel is supported by two slidable beams that slide in and out beneath a floor of said truck box as said bin tunnel slides into said closed position and out to said open position respectively.

9. A collection system as claimed in claim 8 wherein said bin tunnel has two drawer slides near said top, said drawer slides extending into said truck box.

10. A collection system as claimed in claim 8 wherein a depth of said bin tunnel is a distance between said inner and said outer wall, when said bin tunnel is in said closed position being substantially less than fifty (50) percent of a depth when said bin tunnel is in said open position.

11. A mobile collection system as claimed in claim 10 wherein a depth of said bin tunnel is a distance between said inner and said outer wall, when said bin tunnel is in said closed position being substantially less than forty (40) percent of a depth when said bin tunnel is in said open position.

12. A mobile collection system as claimed in claim 10 wherein a depth of said bin tunnel is a distance between said inner and said outer wall, when said bin tunnel is in said closed position being substantially less than thirty (30) percent of a depth when said bin tunnel is in said open position.

13. A mobile collection system as claimed in claim 11 wherein when said bin tunnel is in said closed position, a space within said bin tunnel is substantially occupied by said lift mechanism and by said sidewalls.

14. A collection system as claimed in claim 1 wherein said bin tunnel has a footprint in said closed position that is less than forty (40) percent of a footprint of said bin tunnel when said bin tunnel is in said open position.

15. A collection system as claimed in claim 1 wherein said bin tunnel has a lock to lock said bin tunnel in said closed position.

16. A collection system as claimed in claim 1 wherein said bin tunnel is a first bin tunnel and there is a second bin tunnel mounted in a side of said truck box.

17. A collection system as claimed in claim 1 wherein said bin tunnel is a first bin tunnel and there is a second bin tunnel mounted in a side of said truck box, said second bin tunnel having a different size than said first bin tunnel to accommodate bins having a difference size than bins used with said first bin tunnel.

18. A mobile collection system as claimed in claim 1 wherein said inner wall is recessed inside said side of said truck box by substantially thirteen (13) inches.

19. A mobile collection system comprising a truck having a truck box with a bin tunnel located in a side of the truck box to load content from a bin into said truck box, said bin being sized to fit within said bin tunnel on a lift mechanism that can raise and tip said bin, said bin tunnel having a fixed inner wall in said truck box, two sidewalls and an outer wall with slidable supports to enable said sidewalls and said outer wall to be moved outward and inward relative to said inner wall between an open position and a closed position respectively, said sidewalls being collapsible so that a depth of said bin tunnel in said closed position is significantly less than a depth of said bin tunnel in said open position, said bin fitting within said bin tunnel when said bin tunnel is in said open position, said lift mechanism mounted on said inner wall, said inner wall being a recessed wall of said truck box, said outer wall being substantially flush with a side of said truck box when said bin tunnel is in said closed position.

20. A collection system as claimed in claim 19 wherein said bin tunnel is a first bin tunnel and said truck box has a second bin tunnel located on said side of said truck box.

21. A mobile collection system having a truck box and a bin tunnel located on a side of said truck box to load content into said truck box using a bin that is sized to fit into said bin tunnel, said bin tunnel having an outer portion being a front, top and two sides and an inner portion with a lift mechanism mounted on an inner wall thereof, said inner wall being fixed, said outer portion being slidably supported on said truck box to enable said outer portion to be moved outward from said truck box to an open position of said bin tunnel and moved inward to a closed position of said bin tunnel in which said front is substantially flush with an outer wall of said truck box, said outer portion of said bin tunnel being supported on said truck box independently of said sides, said sides being collapsible relative to said front, in said open position said bin tunnel having sufficient height, depth and width to receive said bin, said lift mechanism in said bin tunnel being constructed to removably connect to said bin and to raise said bin upward within said bin tunnel and tilt said bin to empty the contents of said bin into said truck box, a depth of said bin tunnel in said closed position being substantially less than fifty (50) percent of a depth of said bin tunnel in said open position, said sides of the bin tunnel being extended in said open position and retracted in said closed position.
